(19) United States
(12) Patent Application Publication
(10) Pub. No.: US 2023/0132638 A1
(43) Pub. Date: May 4, 2023

(54) PROCESSING APPARATUS AND METHOD FOR TRAFFIC MANAGEMENT OF A NETWORK OF ROADS

(71) Applicant: GRABTAXI HOLDINGS PTE. LTD., Singapore (SG)

(72) Inventors: Abhinav SUNDERRAJAN, Singapore (SG); Jagannadan VARADARAJAN, Singapore (SG); Robinson Immanuel KUDALI, Singapore (SG); Xiaocheng HUANG, Singapore (SG)

(21) Appl. No.: 17/914,814

(22) PCT Filed: Apr. 13, 2020
(86) PCT No.: PCT/SG2020/050223

§ 371 Date: Sep. 27, 2022

(51) Int. Cl. G08G 1/09; G01C 21/00; G08G 1/01

(52) U.S. Cl. CPC G08G 1/093; G01C 21/3815; G08G 1/0145

(57) ABSTRACT

A processing apparatus for traffic management of a network of roads is provided, to, process data corresponding to the network of roads to identify an incoming road and an outgoing road intersecting at an intersection node of the network, the incoming road being for incoming traffic leading to the intersection node and the outgoing road being for outgoing traffic leading away from the intersection node, determine, based on the data corresponding to the network, whether there is a bypass road to allow the incoming traffic from the incoming road to bypass the intersection node and flow to the outgoing road via the bypass road, and, if it is determined that there is the bypass road, generate data indicative of a turn restriction for communicating to road users of restriction of flow of the incoming traffic to the outgoing road via the intersection node.

### TECHNICAL FIELD

The invention relates generally to the field of communications. One aspect of the invention relates to a processing apparatus for traffic management of a network of roads. Another aspect of the invention relates to a method for traffic management of a network of roads.

One aspect of the invention has particular, but not exclusive, application to navigation (e.g., for vehicles) through a network of roads.

### BACKGROUND

Digital road networks, including OpenStreetMap (OSM), etc., have proliferated over the past few years due to the increasing availability of driver trajectories, satellite images and advances in computer vision. While some digital maps are proprietary, OSM is crowd sourced and free.

Digital road network graphs are associated with several attributes such as direction of travel (DoT), street names, turn restrictions, U-turns, complex traffic intersections, number of lanes, road types, toll roads, traffic lights etc. It is essential that the aforementioned road attributes are correct to ensure that the given map can be used for routing and navigation. The features should not only be correct but should be periodically maintained and validated to account for the addition of new roads, new traffic rules, temporary/permanent road closures, and to ensure seamless and safe navigation capabilities.

### SUMMARY

Aspects of the invention are as set out in the independent claims. Some optional features are defined in the dependent claims.

Implementation of the techniques disclosed herein may provide significant technical advantages. The techniques may enable navigation of traffic through a network of roads. The techniques may enable determination of a bypass or turning road that allows traffic from an incoming road to turn freely, via the bypass road, onto an outgoing road, without the traffic having to reach a downstream intersection node at which the incoming road and the outgoing road intersect. When such a bypass road is determined to be provided for, a turn restriction may be flagged to indicate prohibition to traffic turning from the incoming road to the outgoing road via the intersection node. This may enable one or more of (i) improved navigation experience for road users, (ii) better traffic management that may minimise traffic (congestion) at the intersection node, (iii) better traffic management to allow smoother flow of traffic via the bypass road, (iv) alert road users of turn restrictions in advance to minimise incidences of road users turning onto the outgoing road via the intersection node, thereby potentially minimising traffic disruption at the intersection node, (v) improved safety at the intersection node by diverting traffic via the bypass road from at least one incoming road, where there may be multiple streams of incoming and outgoing traffic converging at or passing through the intersection node, (vi) compliance with restriction imposed at the intersection node, and (vii) savings in terms of travelling time and cost.

In at least some implementations, the techniques disclosed herein may provide for determination of a bypass road based on a geometry of the network of roads. The techniques may further allow determination of the directional flow of traffic through the bypass road based on the geometry of the road network.

In at least some implementations, the techniques disclosed herein may be applicable to intersection nodes having a traffic light arrangement.

In an exemplary implementation, the functionality of the techniques disclosed herein may be implemented in software running on a handheld communications device, such as a mobile phone. The software which implements the functionality of the techniques disclosed herein may be contained in an “app”—a computer program, or computer program product—which the user has downloaded from an online store. When running on the, for example, user's mobile telephone, the hardware features of the mobile telephone may be used to implement the functionality described below, such as using the mobile telephone's transceiver components to establish the secure communications channel for traffic management of a network of roads.

### BRIEF DESCRIPTION OF THE DRAWINGS

The invention will now be described, by way of example only, and with reference to the accompanying drawings in which:

FIG. 1 is a schematic block diagram illustrating an exemplary communications system involving a communications server apparatus.

FIG. 2A shows a schematic block diagram illustrating a processing apparatus for traffic management of a network of roads.

FIG. 2B shows a flow chart illustrating a method for traffic management of a network of roads.

FIG. 3 shows an example of a section of a road network graph.

FIGS. 4A and 4B show examples of different types of intersections.

FIGS. 5A and 5B show examples of road network graphs for a hash intersection and a T intersection respectively.

FIG. 6 shows a flow chart illustrating the methodology or algorithm for modelling hash and T intersections with traffic lights, as a non-limiting example.

FIG. 7 shows an example of a road network graph for a hash intersection with a no free turn.

### DETAILED DESCRIPTION

Various embodiments may include techniques, which may include one or more systems and/or one or more apparatus and/or one or more methods, to discover one or more road attributes so as to provide an aid for routing and navigation, for example, from crowd sourced GPS (Global Positioning System) traces.

The techniques disclosed herein may make use of one or more of (i) statistical insights derived from large scale GPS trajectory data that may be in the possession of a service provider for, for example, transport-related services, (ii) map geometry models from internal maps (e.g., maps that may be available internally to or within a service provider) and open source map providers including Open Street Maps (OSM), (iii) application of artificial intelligence (AI)/machine learning (ML) models on GPS traces along with several other road attributes, and (iv) multitude of sensor signals such as speed, bearing, inertial motion sensor based readings, etc.

The techniques may provide for one or more methods to (automatically) discover and/or predict and/or validate one or more road attributes that may be needed for routing and navigation, such as turn restrictions. This may be carried out by leveraging GPS traces obtained, for example, from millions of transport-related services (e.g., rides) along with artificial intelligence (AI), and machine learning (ML) methods, domain knowledge of the underlying map geometry and associative knowledge from points-of-interest (POIs) (e.g., buildings, landmarks, etc) that are on the road network of interest. For example, whether a road segment involves an intersection with other (one or more) road segments, and if so, whether there is an associated traffic light or not, may be detected and/or validated. As a further example, whether a turn from a road segment (e.g., road segment A) to another road segment (e.g., road segment B) is possible or restricted may be detected and/or validated.

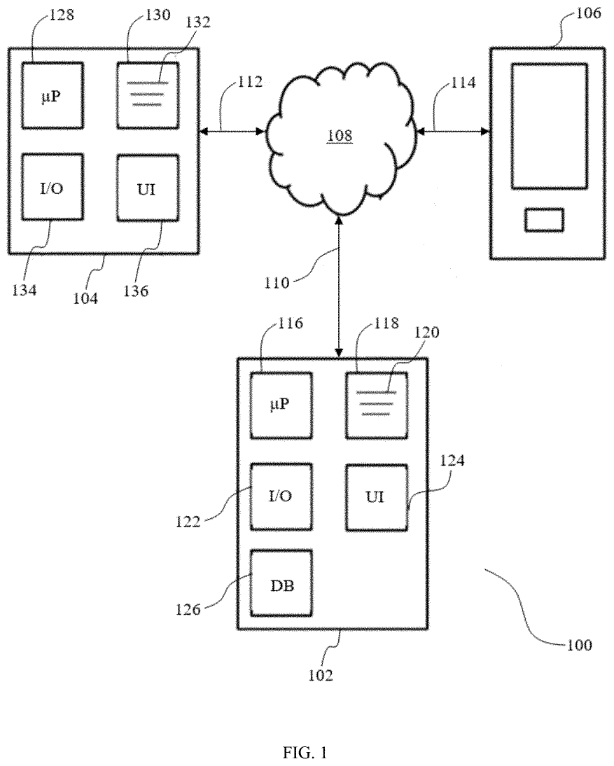

Referring first to FIG. 1, a communications system 100 is illustrated, which may be applicable in various embodiments. The communications system 100 includes a communications server apparatus 102, a first user (or client) communications device 104 and a second user (or client) communications device 106. These devices 102, 104, 106 are connected in or to the communications network 108 (for example, the Internet) through respective communications links 110, 112, 114 implementing, for example, internet communications protocols. The communications devices 104, 106 may be able to communicate through other communications networks, such as public switched telephone networks (PSTN networks), including mobile cellular communications networks, but these are omitted from FIG. 1 for the sake of clarity. It should be appreciated that there may be one or more other communications devices similar to the devices 104, 106.

The communications server apparatus 102 may be for traffic management of a network of roads.

The communications server apparatus 102 may be a single server as illustrated schematically in FIG. 1, or have the functionality performed by the communications server apparatus 102 distributed across multiple server components. In the example of FIG. 1, the communications server apparatus 102 may include a number of individual components including, but not limited to, one or more microprocessors (μP) 116, a memory 118 (e.g., a volatile memory such as a RAM (random access memory)) for the loading of executable instructions 120, the executable instructions 120 defining the functionality the server apparatus 102 carries out under control of the processor 116. The communications server apparatus 102 may also include an input/output (I/O) module 122 allowing the server apparatus 102 to communicate over the communications network 108. User interface (UI) 124 is provided for user control and may include, for example, one or more computing peripheral devices such as display monitors, computer keyboards and the like. The communications server apparatus 102 may also include a database (DB) 126, the purpose of which will become readily apparent from the following discussion.

The user communications device 104 may include a number of individual components including, but not limited to, one or more microprocessors (μP) 128, a memory 130 (e.g., a volatile memory such as a RAM) for the loading of executable instructions 132, the executable instructions 132 defining the functionality the user communications device 104 carries out under control of the processor 128. User communications device 104 also includes an input/output (I/O) module 134 allowing the user communications device 104 to communicate over the communications network 108. A user interface (UI) 136 is provided for user control. If the user communications device 104 is, say, a smart phone or tablet device, the user interface 136 may have a touch panel display as is prevalent in many smart phone and other handheld devices. Alternatively, if the user communications device 104 is, say, a desktop or laptop computer, the user interface may have, for example, one or more computing peripheral devices such as display monitors, computer keyboards and the like.

The user communications device 106 may be, for example, a smart phone or tablet device with the same or a similar hardware architecture to that of the user communications device 104.

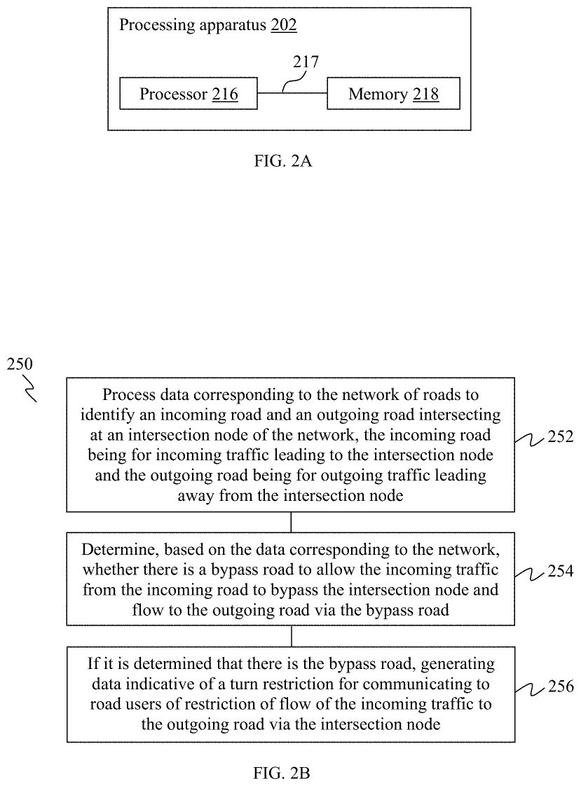

FIG. 2A shows a schematic block diagram illustrating a processing apparatus 202 for traffic management of a network of roads. The processing apparatus 202 includes a processor 216 and a memory 218, where the processing apparatus 202 is configured, under control of the processor 216 to execute instructions in the memory 218 to, process data corresponding to the network of roads to identify an incoming road and an outgoing road intersecting at an intersection node of the network, the incoming road being for incoming traffic leading to the intersection node and the outgoing road being for outgoing traffic leading away from the intersection node, determine, based on the data corresponding to the network, whether there is a bypass road to allow the incoming traffic from the incoming road to bypass the intersection node and flow to the outgoing road via the bypass road, and, if it is determined that there is the bypass road, generate data indicative of a turn restriction for communicating to road users of restriction of flow of the incoming traffic to the outgoing road via the intersection node. The processor 216 and the memory 218 may be coupled to each other (as represented by the line 217), e.g., physically coupled and/or electrically coupled.

In other words, there may be provided a processing apparatus 202 for managing traffic of a network of roads. The processing apparatus 202 may process data corresponding to or indicative of the network of roads to identify an intersection node of the network, and to identify an incoming road for incoming traffic and an outgoing road for outgoing traffic intersecting at the intersection node. In other words, the incoming road and the outgoing road may be connected to each other at the intersection node. The intersection node, the incoming road and the outgoing road may, therefore, define an intersection for the network of roads. The data corresponding to the network of roads may be stored in the processing apparatus 202, e.g., in the memory 218, or the data corresponding to the network of roads may be stored in another location (e.g., in a server) and may be received by or accessible to the processing apparatus 202.

In the context of various embodiments, the data corresponding to the network of roads may include, but not limited to, data or information on one or more of the plurality of roads within the network, relationship between the roads (e.g., including any connection therebetween), geometrical layout of the network, direction of traffic on respective roads (e.g., including whether the roads may be roads for one-way traffic or bi-directional traffic), intersection nodes, traffic light arrangements, road classification (e.g., whether the roads are major or minor roads, residential roads, highways, etc.), dimensions of the roads (e.g., lengths, widths), names of the roads, etc.

The processing apparatus 202 may further determine, based on the data corresponding to the network, or put in another way, the processing apparatus 202 may process the data corresponding to the network to determine, whether there is a bypass road (or turning road) to allow the incoming traffic to flow, via the bypass road, onto the outgoing road as the outgoing traffic, bypassing the intersection node. This may mean that a bypass road may be connected to the incoming road and the outgoing road. Such a bypass road is generally upstream of the intersection node, where traffic may first encounter the bypass road compared to the intersection node located further downstream.

If it is determined that there exists such a bypass road, the processing apparatus 202 may generate data indicative of a turn restriction (or prohibition) for communicating to road users of restriction (or prohibition or prevention) of flow of the incoming traffic to the outgoing road via the intersection node (e.g., no turning into the outgoing road from the incoming road via the intersection node). The data indicative of the turn restriction may be communicated to the road users via (communications) devices of the road users.

A road user may be alerted to the turn restriction by means of visual information or alert, including but not limited to, textual information, graphical information, etc. As non-limiting examples, the data indicative of a turn restriction may be presented in visual form, for example, graphically via use of colour schemes, patterns, symbols or characters, e.g., placing of a “x” at a suitable location on a digital map to indicate no turning from the incoming road to the outgoing road via the intersection node, or may be presented in textual form (e.g., “No turning into Road Y from Road X at Intersection Z”) on the digital map or via the (communications) device to alert the user of such turn restrictions.

In the context of various embodiments, the (communications) device of a road user may include, but not limited to, a smart phone, tablet, handheld/portable communications device, desktop or laptop computer, terminal computer, navigation device (including an in-vehicle navigation device), etc.

In the context of various embodiments, a bypass road may be defined as a connecting road connected to the incoming road and the outgoing road or a connecting road that intersects the incoming road and the outgoing road. A bypass road may connect a node of the incoming road to a node of the outgoing road. A bypass road may be defined as a road connecting an enter (or entry) node associated with an incoming road and an exit node associated with an outgoing road. The entry node may be for a road segment of the incoming road, where the incoming traffic enters the road segment from (or via) the entry node. The entry node may be where a road intersects the incoming road. The exit node may be for a road segment of the outgoing road, where the outgoing traffic exits the road segment through (or via) the exit node. The exit node may be where a road intersects the outgoing road.

As an example, the apparatus 202 may process the data corresponding to the network of roads to identify an entry node for (or corresponding to) a first (road) segment of the incoming road and an exit node for (or corresponding to) a second (road) segment of the outgoing road, wherein, for determining whether there is the bypass road, the apparatus 202 may determine, based on the data corresponding to the network, whether there is a connecting road connected to the entry node and the exit node, and if there is the connecting road, generate data indicative of the connecting road being the bypass road.

In various embodiments, the data corresponding to the network may include data indicative of a geometrical layout of the network of roads, and, for determining whether there is the bypass road, the apparatus 202 may determine whether there is the bypass road based on the data indicative of the geometrical layout of the network.

In the context of various embodiments, the data indicative of the geometrical layout of the network of roads may include, but not limited to, data or information on one or more of geometrical arrangement of the roads, geometrical relationship (e.g., including angular relationship) between the roads, shapes of the roads (e.g., whether the roads are straight roads, curved roads, etc.), curvatures of the roads, etc.

For determining whether there is the bypass road, the apparatus 202 may determine, based on the data indicative of the geometrical layout, an angular relationship between the outgoing road and a candidate road connected to the incoming road and the outgoing road, and generate data indicative of the candidate road being the bypass road if the angular relationship satisfies an angular condition for designating the candidate road as the bypass road. As a non-limiting example, the angular condition may include or may be a reflex angle of about 310° or more between the outgoing road and the candidate road.

The apparatus 202 may further determine, based on the data indicative of the geometrical layout, an angular relationship between the incoming road and the outgoing road, and generate data indicative of a directional flow of the incoming traffic through the bypass road based on the angular relationship between the incoming road and the outgoing road.

If the angular relationship between the incoming road and the outgoing road is determined, starting from the incoming road to the outgoing road in an anti-clockwise direction, to be a reflex angle of between about 220° and about 305°, the apparatus 202 may, for generating the data indicative of the directional flow, generate data indicative of a left directional flow. This may mean that the outgoing road may involve a left turn from the incoming road. In this scenario, incoming traffic on the incoming road may be prohibited from turning left onto the outgoing road via the intersection node, i.e., the data indicative of a turn restriction may be representative of a “no-left turn”. Further, this may mean that the bypass road may provide a free left turn for the incoming traffic on the incoming road flowing to the outgoing road.

If the angular relationship between the incoming road and the outgoing road is determined, starting from the incoming road to the outgoing road in a clockwise direction, to be a reflex angle of between about 220° and about 305°, the apparatus 202 may, for generating the data indicative of the directional flow, generate data indicative of a right directional flow. This may mean that the outgoing road may involve a right turn from the incoming road. In this scenario, incoming traffic on the incoming road may be prohibited from turning right onto the outgoing road via the intersection node, i.e., the data indicative of a turn restriction may be representative of a “no-right turn”. Further, this may mean that the bypass road may provide a free right turn for the incoming traffic on the incoming road flowing to the outgoing road.

In various embodiments, the intersection node may include or may be an intersection node with a traffic light, and, for processing the data corresponding to the network of roads, the apparatus 202 may process the data corresponding to the network of roads to identify an incoming road and an outgoing road intersecting at the intersection node with the traffic light. This may mean that the traffic management relates to an intersection node with a traffic light in the network of roads.

In various embodiments, the intersection node may include or may be an intersection node where at least two incoming roads and at least two outgoing roads intersect, and, for processing the data corresponding to the network of roads, the apparatus 202 may process the data corresponding to the network of roads to identify an incoming road out of the at least two incoming roads and an outgoing road out of the at least two outgoing roads. This may mean that, with at least two incoming roads and at least two outgoing roads, the intersection node has a degree of at least four. The degree of a node refers to the sum of the incoming and outgoing roads at the node.

The apparatus 202 may further add (or include or incorporate) the data indicative of the turn restriction to the data corresponding to the network of roads.

The apparatus 202 may further, in response to a request from a road user to access data associated with the intersection node, communicate the data indicative of the turn restriction to a device of the road user for communicating the turn restriction to the road user.

The apparatus 202 may further process the data indicative of the turn restriction to generate visual information (corresponding to or associated with the turn restriction) for communicating the turn restriction to the road users.

The apparatus 202 may further process data indicative of a digital (or electronic) map representative of the network of roads and the data indicative of the turn restriction for displaying the digital map with information corresponding to the turn restriction. The information corresponding to the turn restriction may be in the form of visual information. The data indicative of the digital map may be stored in the processing apparatus 202, e.g., in the memory 218, or the data indicative of the digital map may be stored in another location (e.g., in a server) and may be received by or accessible to the processing apparatus.

In the context of various embodiments, the processing apparatus 202 may be or may include a communications server apparatus, and may, for example, be as described in the context of the server device 102 (FIG. 1). The processor 216 may be as described in the context of the processor 116 (FIG. 1) and/or the memory 218 may be as described in the context of the memory 118 (FIG. 1).

In the context of various embodiments, the processing apparatus 202 may be a single server, or have the functionality performed by the processing apparatus 202 distributed across multiple apparatus components.

In the context of various embodiments, the processing apparatus 202 may be or may include a (communications) device of a road user.

FIG. 2B shows a flow chart 250 illustrating a method for traffic management of a network of roads.

At 252, data corresponding to the network of roads is processed to identify an incoming road and an outgoing road intersecting at an intersection node of the network, the incoming road being for incoming traffic leading to the intersection node and the outgoing road being for outgoing traffic leading away from the intersection node.

At 254, based on the data corresponding to the network, it is determined whether there is a bypass road to allow the incoming traffic from the incoming road to bypass the intersection node and flow to the outgoing road via the bypass road.

At 256, if it is determined that there is the bypass road, data indicative of a turn restriction is generated for communicating to road users of restriction of flow of the incoming traffic to the outgoing road via the intersection node.

In various embodiments, the method may further include processing the data corresponding to the network of roads to identify an entry node for a first segment of the incoming road and an exit node for a second segment of the outgoing road. At 254, it is determined, based on the data corresponding to the network, whether there is a connecting road connected to the entry node and the exit node, and, if there is the connecting road, data indicative of the connecting road being the bypass road may be generated.

The data corresponding to the network may include data indicative of a geometrical layout of the network, and, at 254, it is determined whether there is the bypass road based on the data indicative of the geometrical layout of the network.

In various embodiments, at 254, the method may include determining, based on the data indicative of the geometrical layout, an angular relationship between the outgoing road and a candidate road connected to the incoming road and the outgoing road, and generating data indicative of the candidate road being the bypass road if the angular relationship satisfies an angular condition for designating the candidate road as the bypass road. The angular condition may include a requirement that a reflex angle between the outgoing road and the candidate road is about 310° or more.

The method may further include determining, based on the data indicative of the geometrical layout, an angular relationship between the incoming road and the outgoing road, and generating data indicative of a directional flow of the incoming traffic through the bypass road based on the angular relationship between the incoming road and the outgoing road.

If the angular relationship between the incoming road and the outgoing road is determined, starting from the incoming road to the outgoing road in an anti-clockwise direction, to be a reflex angle of between about 220° and about 305°, the method may include generating data indicative of a left directional flow.

If the angular relationship between the incoming road and the outgoing road is determined, starting from the incoming road to the outgoing road in a clockwise direction, to be a reflex angle of between about 220° and about 305°, the method may include generating data indicative of a right directional flow.

The intersection node may include an intersection node with a traffic light, and, at 252, the data corresponding to the network of roads may be processed to identify an incoming road and an outgoing road intersecting at the intersection node with the traffic light.

The intersection node may include an intersection node where at least two incoming roads and at least two outgoing roads intersect, and, at 252, the data corresponding to the network of roads may be processed to identify an incoming road out of the at least two incoming roads and an outgoing road out of the at least two outgoing roads.

The method may further include adding the data indicative of the turn restriction to the data corresponding to the network of roads.

The method may further include, in response to a request from a road user to access data associated with the intersection node, communicating the data indicative of the turn restriction to a device of the road user for communicating the turn restriction to the road user.

The method may further include processing the data indicative of the turn restriction to generate visual information for communicating the turn restriction to the road users.

The method may further include processing data indicative of a digital (or electronic) map representative of the network of roads and the data indicative of the turn restriction for displaying the digital map with information corresponding to the turn restriction.

The method as described in the context of the flow chart 250 may be performed in a processing apparatus (e.g., 202; FIG. 2A) for traffic management of a network of roads, under control of a processor of the apparatus.

It should be appreciated that descriptions in the context of the processing apparatus 202 may correspondingly be applicable in relation to the method as described in the context of the flow chart 250, and vice versa.

In the context of various embodiments, data that is generated, for example, by a processing apparatus (e.g., 202) and/or as part of one or more methods disclosed herein, may be generated for or in one or more data records. The one or more data records may be associated with or accessible by the processing apparatus. The one or more data records may be generated by the processing apparatus. The one or more data records may be modified or updated by the processing apparatus. The one or more data records may be stored at the processing apparatus, e.g., in a memory of the processing apparatus.

In the context of various embodiments, the one or more data records may include one or more data fields for the corresponding data that is generated. As a non-limiting example, the data indicative of a turn restriction may be generated for or in one or more “restriction data fields” of the one or more data records. As a further non-limiting example, the data indicative of the candidate road being the bypass road may be generated for or in one or more “candidate data fields” of the one or more data records. As a yet further non-limiting example, the data indicative of a directional flow of the incoming traffic may be generated for or in one or more “direction data fields” of the one or more data records.

There may also be provided a computer program product having instructions for implementing the method for traffic management of a network of roads as described herein.

There may also be provided a computer program having instructions for implementing the method for traffic management of a network of roads as described herein.

There may further be provided a non-transitory storage medium storing instructions, which, when executed by a processor, cause the processor to perform the method for traffic management of a network of roads as described herein.

Various embodiments may enable determination of turn restrictions at intersections (e.g., intersections with traffic lights and/or free turns). Generally, at an intersection, an incoming road for traffic travelling in a direction to(wards) the intersection may be linked or connected to an ongoing road for traffic travelling in a direction away from the intersection via an intersection node.

The techniques disclosed herein may determine whether there is a turning road (or bypass road) providing free turn from an incoming road to an outgoing road that bypasses a downstream intersection node which the incoming and outgoing roads are connected to one another, and, may further determine any turn restriction for the outgoing road via the intersection node. The intersections may include, but not limited to, hash intersections and T intersections. In the context of various embodiments, the intersections (or intersection nodes) include intersections with a traffic light.

As a non-limiting example, the techniques may identify, from all candidate intersection nodes, the nodes where there may be two incoming roads and two outgoing roads which are one-way roads. For each of the nodes identified, the techniques may identify the relevant turn from the associated incoming road to the corresponding outgoing road based on an angle, θ, of the outgoing road relative to the incoming road. As a non-limiting example, the relevant turn may be identified as a left turn if 220°≤θ≤305°.

The techniques may further identify whether there is a free turn from the incoming road to the outgoing road (i.e., whether there is a turning or bypass road connecting the incoming road to the outgoing road without traffic having to reach the intersection node linking the incoming and outgoing roads to one another) on the basis of an angle, α, of the turning road relative to the outgoing road. As a non-limiting example, for a left turn situation, a free (left or right) turn may be identified if α>310°.

If a free turn is identified (i.e., there is a bypass road) for traffic going from the incoming road to the outgoing road to bypass the corresponding intersection (node) linking the two roads, the techniques may further flag the outgoing road with or as having a turn restriction, meaning that traffic may be discouraged or prohibited from turning into the outgoing road from the incoming road via the intersection (node).

Various embodiments or techniques will now be further described in detail.

Generally, a road network may be represented as a directed graph G(V, E), where V refers to a set of nodes and E refers to a set of directed edges connecting the nodes. Two nodes may be linked by an “edge”, referring to a road segment. Multiple road segments may make up a road. A node may be associated with one or more incoming edges leading to the node, and/or one or more outgoing edges leading away from the node. The network graph structure may enable identification of the number of incoming edges and/or outgoing edges.

A road on a road network graph may have 2 or more nodes. If a road has “n” nodes, the road may have “n−1” edges or segments. Each segment is generally a straight line segment. The curvature of a road, thus, may be given by multiple line segments (or road segments).

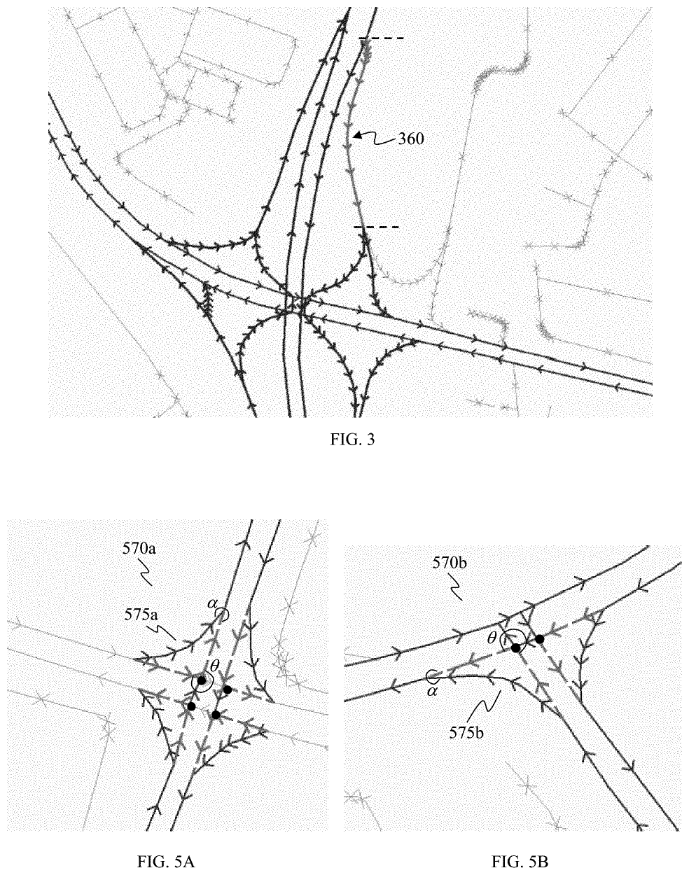

FIG. 3 shows an example of a section of a road network graph. Using the road 360, with its boundaries indicated with the two dashed lines, as a non-limiting example, the road 360 may have an identifier or ID (i.e., road ID), e.g., 22718052. While not clearly shown in FIG. 3, road 360 has 11 road segments and 12 nodes. In FIG. 3, nodes are represented by the arrow heads while road segments are defined by the lines between respective two adjacent nodes. Each node may have its own identifier or ID (i.e., node ID), e.g., 133745557, 6076301329, 6076301328, etc.

Referring to FIG. 3, roads with cross marks (“x”) represent bi-directional roads with two-way traffic, while roads with arrows (e.g., road 360) represent one-way roads.

Further, the graph structure, similar to that shown in FIG. 3, may allow identification of the number of incoming and outgoing edges, i.e., roads at every node in the road network graph.

Techniques disclosed herein may provide for rule based modelling of traffic intersections. Based on the degree of nodes in the road network graph and the angles between the edges incident on a node, a methodology may be provided to identify nodes associated with traffic lights and/or identify turn restrictions at complex traffic intersections. Such information can be leveraged by travel time estimation models as well as being relevant (and potentially crucial) for navigation purposes.

Compared to known approaches, the techniques disclosed herein may also leverage upon the angle between incoming and outgoing edges to recommend one or more of no-left, no-right and no-entry suggestions, which is relevant or necessary for navigation.

The techniques disclosed herein may enable determining or modelling turn restrictions on (structured) intersections (e.g., hash and T intersections), including intersections with traffic lights.

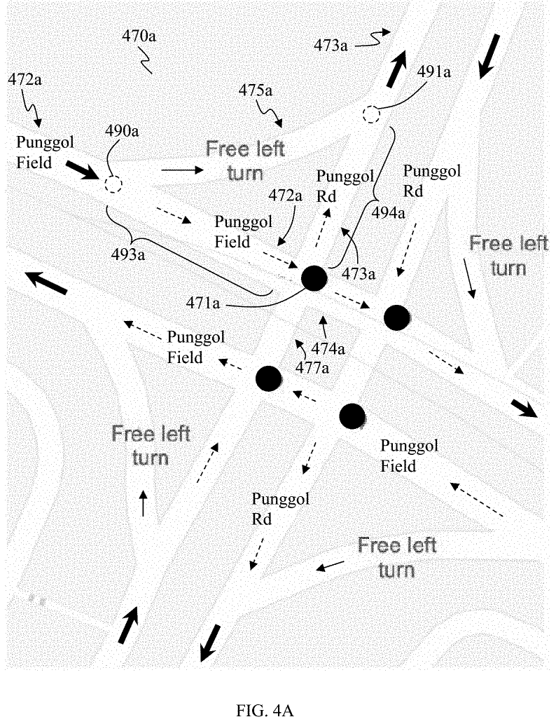

Cities around the world have a structure to their traffic intersections. For example, in Singapore, a vast majority of the intersections (including intersections with traffic lights) may fall under the category of hash or T intersections (see FIGS. 4A and 4B). These intersections may have a free (left) turn with left turn prohibited once traffic or vehicles pass the free (left) turn link associated with the intersection nodes. Some of these intersections may have a free (right) turn.

Referring to the example in FIG. 4A showing a hash intersection 470a, there are four intersection nodes indicated by solid circles (e.g., represented by 471a for one solid circle). Using the node 471a as a non-limiting example, but which the following description is applicable also to the other three nodes, there is an incoming road 472a for incoming traffic leading to the node 471a and an outgoing road 473a for outgoing traffic leading away from the node 471a. The incoming road 472a and the outgoing road 473a may intersect at the node 471a, or may be connected to one another at the node 471a. There is another incoming road 477a leading to the node 471a. There is also another outgoing road 474a leading away from the node 471a. With two incoming roads 472a, 477a, and two outgoing roads 473a, 474a intersecting at the node 471a, the intersection node 471a has a degree of four. There may be a traffic light provided at the node 471a.

There is a turning road or bypass road 475a that links the incoming road 472a and the outgoing road 473a to each other, providing a free turn from the incoming road 472a to the outgoing road 473a that bypasses the downstream intersection node 471a. Based on the structure or geometrical layout of the road network shown in FIG. 4A, the bypass road 475a provides a free left turn.

As non-limiting examples, also illustrated in FIG. 4A is a dashed circle 490a to identify the entry node for the segment 493a of the incoming road 472a and another dashed circle 491a to identify the exit node for the segment 494a of the outgoing road 473a, with the bypass road 475a connected to the entry node 490a and the exit node 491a.

Referring to the example in FIG. 4B showing a T intersection 470b, there are four intersection nodes indicated by solid circles (e.g., represented by 471b for one solid circle). Using the node 471b as a non-limiting example, but which the following description is applicable also to the other node 476b, there is an incoming road 472b for incoming traffic leading to the node 471b and an outgoing road 473b for outgoing traffic leading away from the node 471b. The incoming road 472b and the outgoing road 473b may intersect the node 471a, or may be connected to one another at the node 471b. The intersection node 471b may have a degree of four. There may be a traffic light provided at the node 471b.

There is a turning road or bypass road 475b that links the incoming road 472b and the outgoing road 473b to each other, providing a free turn from the incoming road 472b to the outgoing road 473b that bypasses the downstream intersection node 471b. Based on the structure or geometrical layout of the road network shown in FIG. 4B, the bypass road 475b provides a free left turn.

As non-limiting examples, also illustrated in FIG. 4B is a dashed circle 490b to identify the entry node for the segment 493b of the incoming road 472b and another dashed circle 491b to identify the exit node for the segment 494b of the outgoing road 473b, with the bypass road 475b connected to the entry node 490b and the exit node 491b.

It should be appreciated that, for any types of intersections, depending on the structure or geometrical layout of the road network, respective bypass roads may be provided to allow free left turns or free right turns.

With the availability of a bypass road providing a free turn, the techniques disclosed herein may determine that a turn restriction be applied at the corresponding intersection node to restrict or prohibit turning from the incoming road to the outgoing road at or via the corresponding intersection node in the same direction provided for by the bypass road. Accordingly, referring to FIGS. 4A and 4B, there may be turn restrictions of no left turns at the nodes, e.g., nodes 471a, 471b.

Identifying intersections may be useful for both navigation due to the possibilities of free turns (left or right) and no-turn (left- or right) constraints and also for better travel time estimates, where delays caused by vehicles waiting at the intersections may need to be accounted for, moreso, for intersections having traffic lights.

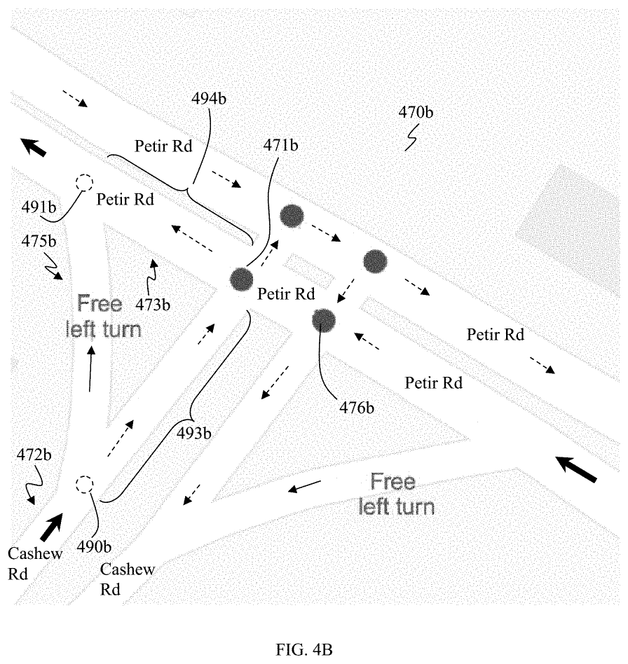

FIGS. 5A and 5B show examples of road network graphs for a hash intersection 570a and a T intersection 570b respectively. Similar to FIG. 3, roads with cross marks (“x”) represent bi-directional roads with two-way traffic, while roads with arrows represent one-way roads.

The intersection nodes are represented by solid circles. Intersection roads or edges with turn restrictions, in the form of no left turns, are represented by dashed arrow lines. There are four bypass roads (e.g., represented by 575a for one bypass road) shown in FIG. 5A and two bypass roads (e.g., represented by 575b for one bypass road) shown in FIG. 5B.

For an intersection node having an incoming road, an outgoing road and an associated bypass road providing free turn, the incoming road and the corresponding outgoing road may be defined, in terms of their relationship, by a (reflex) angle, θ, between the incoming road and the outgoing road, while the outgoing road and the corresponding bypass road may be defined, in terms of their relationship, by a (reflex) angle, α, between the outgoing road and the bypass road, as illustratively shown in FIGS. 5A and 5B respectively for one intersection node and the associated bypass road 575a, 575b.

As intersections have a certain structure, the techniques disclosed herein may make use of the topology of the network to implement a methodology that employs some rules based on the angles between successive edges and/or the number of incoming and outgoing edges at a node.

Non-limiting examples of implementation of the rule based methodology of various embodiments, for modelling intersections (including intersections with traffic lights), are shown below. As a non-limiting example, the following algorithms, written in python, may be used. However, it should be appreciated that similar algorithms or other suitable algorithms may be implemented in other programming languages.

```
intersection_nodes=[ ]
  def is_intersectionNode(node):
  isOneway = true;
  if (len(node.in_edges( )) == 2 && len(node.out edges( )) == 2):
    for in_edge in node.in edges( ):
      isOneway = isOneway && in_edge.isOneWay( )
    for out_edge in node.out_edges ( ):
      isOneway = isOneway && out_edge.isOneWay( )
  if isOneWay:
    intersection_nodes.add(node);
intersectionEdges=[ ]
free_left_turns=[ ]
def identify_intersection_edges( ):
  for node in intersection_nodes:
      for in_edge in node.in_edges:
      for out_edge in node.out_edges:
        angle = computeAngle(in_edge, out_edge, node);
          #represents left turns at a node
        if angle > 220 && angle < 305:
          begin_node = in_edge.begin_node
          for free_left_turn in begin_node.out_roads :
            if free_left_turn.end_node == out_edge.end_node:
              if computeAngle(in_edge, free_left_turn, begin_node) > 310:
                intersectionEdges.add(in_edge)
                intersectionEdges.add(out_edge)
                  free_left_turns.add(free_left_turn)
```

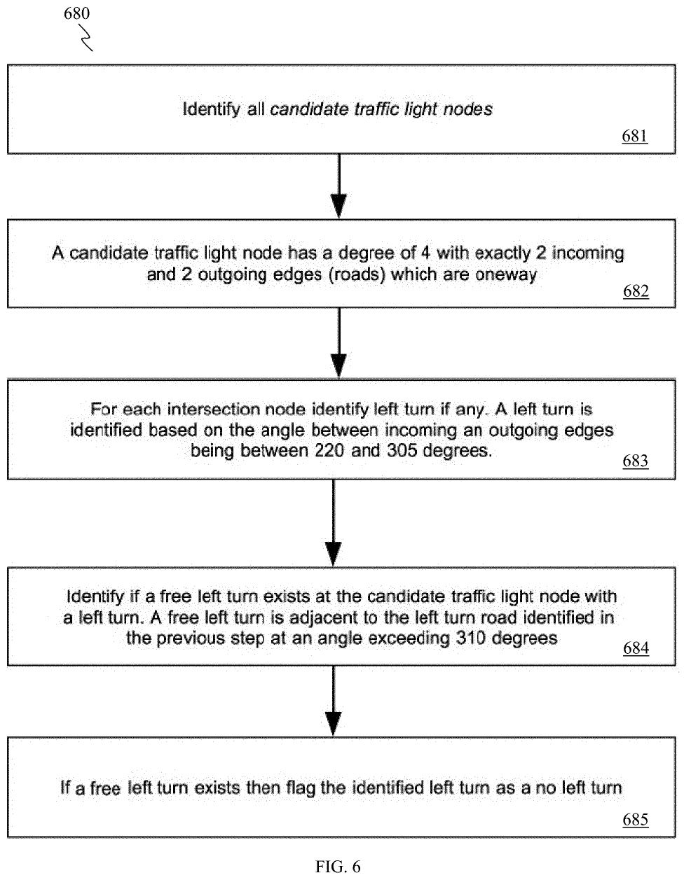

FIG. 6 shows a flow chart 680 illustrating the methodology or algorithm for modelling hash and T intersections with traffic lights and for left turning, as a non-limiting example. Nevertheless, it should be appreciated that the methodology may be applicable to other types of intersections, applicable to any intersections, with or without traffic lights, and applicable for determining free left or right turns.

At 681, candidate intersection nodes having traffic lights are identified. Nevertheless, it should be appreciated that candidate intersection nodes with traffic lights and/or candidate intersection nodes without traffic lights may be identified.

Referring to 682, as a non-limiting example, a traffic light node may be identified as a candidate if the node has a degree of 4 with exactly 2 incoming edges (roads) and 2 outgoing edges (roads), with the roads being one-way. The degree of a node refers to the sum of incoming and outgoing edges at the node.

At 683, for each candidate intersection node, the techniques may determine whether there is a left turn from an incoming edge to an outgoing edge. A left turn may be identified if the (reflex) angle, θ, between the incoming road and the corresponding outgoing road is 220°≤θ≤305° (determined starting from the incoming road to the outgoing road in an anti-clockwise direction). However, it should be appreciated that this is not restricted to a left turn, and it may be determined, for each candidate intersection node, whether there is a left turn or a right turn from an incoming edge to an outgoing edge. Similarly, a right turn may be identified if the (reflex) angle, gyp, between the incoming road and the corresponding outgoing road is 220° 305° (determined starting from the incoming road to the outgoing road in a clockwise direction). It should be appreciated that determination of the angle (θ or φ) between the incoming road and the corresponding outgoing road satisfying the condition 220°≤θ or φ≤305°, and determination of the traffic direction in or along the outgoing road may allow identification of whether the turn is a left turn or a right turn.

At 684, for a candidate traffic light node with a left turn identified at 683, the techniques may further determine whether there is a bypass road providing free left turn. Such a bypass road may be identified if the (reflex) angle, α, between the bypass road and the corresponding adjacent left turn outgoing road is α>310°. Similarly, for a candidate traffic light node with a right turn identified at 683, the techniques may further determine whether there is a bypass road providing free right turn. Such a bypass road may be identified if the (reflex) angle, β, between the bypass road and the corresponding adjacent right turn outgoing road is β>310°.

At 685, if a bypass road for a free left turn is identified, the corresponding left turn outgoing road may be flagged with turn restriction, in the form of no-left turn.

Similarly, if a bypass road for a free right turn is identified, the corresponding right turn outgoing road may be flagged with turn restriction, in the form of no-right turn.

However, it should be appreciated that different conditions, for example, different angular values or range of values, may be set for one or more of θ, φ, α, and β, depending on the configuration or layout or structure of the road network, or applications.

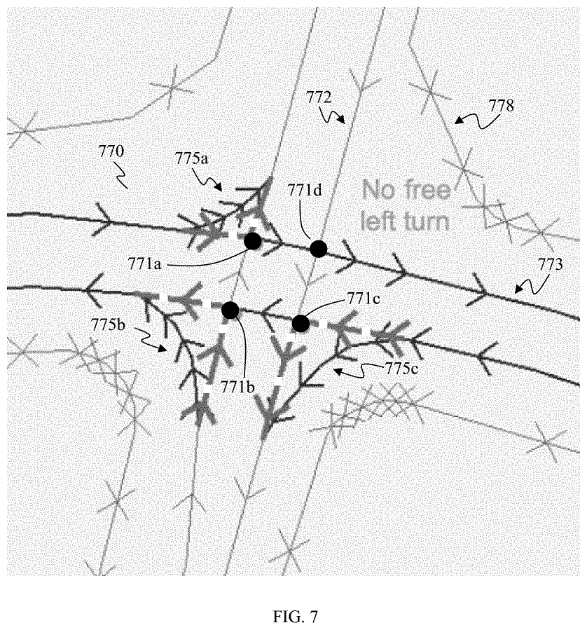

The techniques disclosed herein may be used to identify whether there is a turn (left or right) at an intersection node, and, whether there is a free turn (left or right) at the intersection node. FIG. 7 shows an example of a road network graph for a hash intersection 770. Using the techniques disclosed herein, three nodes 771a, 771b, 771c with left turns and having corresponding respective bypass roads 775a, 775b, 775c providing free left turns may be identified, and, therefore, left turn restrictions may be flagged for the nodes 771a, 771b, 771c, for the intersection roads represented by the dashed arrow lines. There is a fourth node 771d, which despite having a left turn outgoing road has no corresponding bypass road providing free left turn. Therefore, no turn restriction is flagged for the node 771d, meaning that there is no restriction for traffic coming from the incoming road 772 turning into the outgoing road 773 at the intersection node 771d. While there is a road 778, the road 778 is not connected to the incoming road 772 and the outgoing road 773, and therefore does not act as a bypass road for traffic from the incoming road 772 flowing to the outgoing road 773.

As anon-limiting example, the techniques disclosed herein have been used to tag 3354 nodes as traffic lights and modelled 492 intersections with associated no left and free left turns in Singapore. The available OSM version has 2253 nodes marked as having traffic light signals in Singapore. This represents a potential increase of 33% in terms of intersections having traffic lights being identified in Singapore. Further, the techniques have also determined no left turns at the algorithmically identified intersections in Singapore.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1. A processing apparatus for traffic management of a network of roads, comprising a processor and a memory, the apparatus being configured, under control of the processor to execute instructions in the memory to:
process data corresponding to the network of roads to identify an incoming road and an outgoing road intersecting at an intersection node of the network, the incoming road being for incoming traffic leading to the intersection node and the outgoing road being for outgoing traffic leading away from the intersection node;
determine, based on the data corresponding to the network, whether there is a bypass road to allow the incoming traffic from the incoming road to bypass the intersection node and flow to the outgoing road via the bypass road; and
if it is determined that there is the bypass road, determine that there is a turn restriction of flow of the incoming traffic to the outgoing road via the intersection node, and generate data indicative of the turn restriction for communicating to road users.

2. The apparatus as claimed in claim 1, further configured to process the data corresponding to the network of roads to identify an entry node for a first segment of the incoming road and an exit node for a second segment of the outgoing road;
wherein, for determining whether there is the bypass road, the apparatus is configured to:
determine, based on the data corresponding to the network, whether there is a connecting road connected to the entry node and the exit node; and
if there is the connecting road, generate data indicative of the connecting road being the bypass road.

3. The apparatus as claimed in claim 1, wherein the data corresponding to the network comprises data indicative of a geometrical layout of the network, and, for determining whether there is the bypass road, the apparatus is configured to determine whether there is the bypass road based on the data indicative of the geometrical layout of the network.

4. The apparatus as claimed in claim 3, wherein, for determining whether there is the bypass road, the apparatus is configured to:
determine, based on the data indicative of the geometrical layout, an angular relationship between the outgoing road and a candidate road connected to the incoming road and the outgoing road; and
generate data indicative of the candidate road being the bypass road if the angular relationship satisfies an angular condition for designating the candidate road as the bypass road.

5. (canceled)

6. The apparatus as claimed in claim 3, being further configured to:
determine, based on the data indicative of the geometrical layout, an angular relationship between the incoming road and the outgoing road; and
generate data indicative of a directional flow of the incoming traffic through the bypass road based on the angular relationship between the incoming road and the outgoing road.

7. The apparatus as claimed in claim 6,
wherein, if the angular relationship between the incoming road and the outgoing road is determined, starting from the incoming road to the outgoing road in an anti-clockwise direction, to be a reflex angle of between about 220° and about 305°, the apparatus is configured to, for generating the data indicative of the directional flow, generate data indicative of a left directional flow, or
wherein, if the angular relationship between the incoming road and the outgoing road is determined, starting from the incoming road to the outgoing road in a clockwise direction, to be a reflex angle of between about 220° and about 305°, the apparatus is configured to, for generating the data indicative of the directional flow, generate data indicative of a right directional flow.

8-10. (canceled)

11. The apparatus as claimed in claim 1, further configured to add the data indicative of the turn restriction to the data corresponding to the network of roads.

12. The apparatus as claimed in claim 1, further configured to, in response to a request from a road user to access data associated with the intersection node, communicate the data indicative of the turn restriction to a device of the road user for communicating the turn restriction to the road user.

13. The apparatus as claimed in claim 1, further configured to process the data indicative of the turn restriction to generate visual information for communicating the turn restriction to the road users.

14. The apparatus as claimed in claim 1, further configured to process data indicative of a digital map representative of the network of roads and the data indicative of the turn restriction for displaying the digital map with information corresponding to the turn restriction.

15. A method performed in a processing apparatus for traffic management of a network of roads, the method comprising, under control of a processor of the processing apparatus:
processing data corresponding to the network of roads to identify an incoming road and an outgoing road intersecting at an intersection node of the network, the incoming road being for incoming traffic leading to the intersection node and the outgoing road being for outgoing traffic leading away from the intersection node;
determining, based on the data corresponding to the network, whether there is a bypass road to allow the incoming traffic from the incoming road to bypass the intersection node and flow to the outgoing road via the bypass road; and
if it is determined that there is the bypass road, determining that there is a turn restriction of flow of the incoming traffic to the outgoing road via the intersection node, and generating data indicative of the turn restriction for communicating to road users.

16. The method as claimed in claim 15, further comprising processing the data corresponding to the network of roads to identify an entry node for a first segment of the incoming road and an exit node for a second segment of the outgoing road;
wherein determining whether there is the bypass road comprises:
determining, based on the data corresponding to the network, whether there is a connecting road connected to the entry node and the exit node; and
if there is the connecting road, generating data indicative of the connecting road being the bypass road.

17. The method as claimed in claim 15,
wherein the data corresponding to the network comprises data indicative of a geometrical layout of the network, and
wherein determining whether there is the bypass road comprises determining whether there is the bypass road based on the data indicative of the geometrical layout of the network.

18. The method as claimed in claim 17, wherein determining whether there is the bypass road comprises:
determining, based on the data indicative of the geometrical layout, an angular relationship between the outgoing road and a candidate road connected to the incoming road and the outgoing road; and
generating data indicative of the candidate road being the bypass road if the angular relationship satisfies an angular condition for designating the candidate road as the bypass road.

19. (canceled)

20. The method as claimed in claim 17, further comprising:
determining, based on the data indicative of the geometrical layout, an angular relationship between the incoming road and the outgoing road; and
generating data indicative of a directional flow of the incoming traffic through the bypass road based on the angular relationship between the incoming road and the outgoing road.

21. The method as claimed in claim 20,
wherein, if the angular relationship between the incoming road and the outgoing road is determined, starting from the incoming road to the outgoing road in an anti-clockwise direction, to be a reflex angle of between about 220° and about 305°, generating the data indicative of the directional flow comprises generating data indicative of a left directional flow, or
wherein, if the angular relationship between the incoming road and the outgoing road is determined, starting from the incoming road to the outgoing road in a clockwise direction, to be a reflex angle of between about 220° and about 305°, generating the data indicative of the directional flow comprises generating data indicative of a right directional flow.

22-25. (canceled)

26. The method as claimed in claim 15, further comprising, in response to a request from a road user to access data associated with the intersection node, communicating the data indicative of the turn restriction to a device of the road user for communicating the turn restriction to the road user.

27. The method as claimed in claim 15, further comprising processing the data indicative of the turn restriction to generate visual information for communicating the turn restriction to the road users.

28. The method as claimed in claim 15, further comprising processing data indicative of a digital map representative of the network of roads and the data indicative of the turn restriction for displaying the digital map with information corresponding to the turn restriction.

29. A computer program or a computer program product comprising instructions for implementing the method as claimed in claim 15, or a non-transitory storage medium storing instructions, which when executed by a processor cause the processor to perform the method as claimed in claim 15.

30. (canceled)
